(19) United States
(12) Patent Application Publication
(10) Pub. No.: US 2008/0176184 A1
(43) Pub. Date: Jul. 24, 2008

(54) Device for removably fixing and driving a tool in the head of a handpiece

(76) Inventor: Jean-Marie Badoz, Doubs (FR)

Correspondence Address: Gary M. Cohen, Esq., Strafford Building Number Three, 125 Strafford Avenue, Suite 300, Wayne, PA, 19087-3318, US

(21) Appl. No.: 12/079,128

(22) Filed: Mar. 25, 2008

Related U.S. Application Data
(63) Continuation-in-part of application No. 10/575,591, filed on Apr. 12, 2006.

(30) Foreign Application Priority Data
Nov. 5, 2003 (FR) 03/12958

(51) Int. Cl. A61C 1/08

(52) U.S. Cl. 433/127

(57) ABSTRACT

An apparatus for removably fixing a tool to the head of a handpiece including a neck having the head at one end of the neck and a handle at an opposing end of the neck, and interior portions receiving a drive shaft for rotating the tool. The apparatus includes a bore formed in the head of the handpiece, for receiving the tool in the bore of the head, and a toothless friction drive coupled with an end of the drive shaft adjacent to the bore of the head. The friction drive engages shank portions of the tool while received in the bore of the head. The tool is retained in the bore by frictional contact between the shank of the tool and the friction drive coupled with the drive shaft.

### RELATED CASE

This patent application is a continuation-in-part of prior co-pending U.S. patent application Ser. No. 10/575,591, filed Apr. 12, 2006.

### BACKGROUND OF THE INVENTION

The present invention generally relates to the field of dental handpieces or contra-angles, and more particularly, to an apparatus for removably fixing and driving a tool in the head of the handpiece or contra-angle.

The tools intended for use on such handpieces and contra-angles are conventionally provided with shanks complying with ISO 1797, and a variety of known devices are available for removably fixing such tools to the handpieces and contra-angles.

An example of one such device is the apparatus which is disclosed in European Patent No. 0 174 695, and which describes an apparatus that allows the tool to be axially fixed in the head of a handpiece or contra-angle. The disclosed apparatus provides for secure attachment and proper rotation of the tool within the head, but exhibits the disadvantage that a considerable amount of space is taken up by the apparatus, which tends to obstruct the view of the practitioner using the apparatus.

In view of the rapid developments which are presently occurring in the field of dentistry performed under a microscope, it has become essential for the practitioner to have maximum visibility and accessibility, leading to the need for an apparatus that can both fix an instrument in the head of a handpiece or contra-angle and effectively drive the instrument while taking up as little space as is possible.

This applies not only to dentistry performed under a microscope, but also to conventional dental work which is carried out by direct observation. The reason for this is because the smaller the space taken up by the fixing and driving apparatus, the better will be the practitioner's view of the teeth, and the practitioner's access to the work area. This is particularly so for endodontic treatments of the back teeth.

### SUMMARY OF THE INVENTION

The present invention serves to overcome these various disadvantages by providing an apparatus for removably fixing and driving a tool in a handpiece of a small size, in turn permitting the formation of heads for contra-angles that have a very small dimension and that are able to receive standard shanks.

To this end, and in accordance with the present invention, an apparatus is provided which can removably fix a tool to the head of a handpiece and drive the tool while fixed within the head of the handpiece. The handpiece includes a handle and a head which are connected by a neck. Interior portions of the handle, the neck and the head are each provided with a drive shaft for operating a tool fixed to the resulting assembly. To this end, the tool is disposed in a bore formed in the head of the handpiece, and is held inside the bore by frictional contact with the drive shaft.

Preferred embodiments of the apparatus of the present invention are further described hereafter, with reference to the following illustrations.

### BRIEF DESCRIPTION OF THE DRAWINGS

FIG. 1 is a bottom view of a first alternative embodiment handpiece produced in accordance with the present invention.

FIG. 2 is a cross-sectional view of the handpiece shown in FIG. 1, showing a tool which has been fitted to the handpiece in accordance with a first alternative embodiment of the present invention.

FIG. 3 is a bottom view of a second alternative embodiment handpiece produced in accordance with the present invention, having an external system for disengagement of the drive shaft and the tool.

FIG. 4 is a cross-sectional view of the second alternative embodiment handpiece shown in FIG. 3.

### DETAILED DESCRIPTION OF PREFERRED EMBODIMENTS

The handpieces or contra-angles 1 of the present invention generally include an anterior part, or neck 2, having an overall outer shape which is cylindrical and conical, which supports a head 3 at one end and a handle 5 at the opposing end of the neck 2. The head 3 is provided for supporting a tool 4 so that the tool is fixed within the head. The handle 5 has a shape which is substantially cylindrical and/or conical in revolution. Interior portions of the neck 2, the head 3 and the handle 5 are each provided with a drive shaft 6 for ensuring rotation of the tool 4 as will be more fully described below.

The tool 4 can be any of a variety of instruments for performing a dental or endodontic procedure, and conventionally includes a shank 4′ that fits in the head 3 of the handpiece 1. To this end, the shank of the tool 4 fits in a bore 7 formed in the head 3 along a transverse axis which is represented by the broken lines shown in FIGS. 2 and 4.

The shank 4′ of the tool 4 is in direct contact with one of the ends of the drive shaft 6 to in this way provide for rotation of the tool 4. The point of contact between the shank 4′ of the tool 4 and the drive shaft 6 is located on a friction drive 8 which is provided on the end of the drive shaft 6. The friction drive 8 is toothless, and is preferably frusto-conical to provide an inclined surface for matching the shape of the tool 4. The friction drive 8 is advantageously formed as a rubber shroud which overfits the drive shaft 6, as is best shown in FIGS. 2 and 4, for providing desired rotation of the tool 4. As previously indicated, such rotational movements will be produced by frictional engagement between the smooth surfaces constituting the rubber shroud which forms the friction drive 8 and the shank 4′ of the tool 4.

The incline of the friction drive 8 also causes the tool 4 to be pushed to the bottom of the bore 7 during rotation of the tool 4, in this way permitting a secure attachment of the tool 4 within the bore 7. Moreover, if the point of contact between the drive shaft 6 and the shank 4′ of the tool 4 is offset, the mechanical forces caused by rotation of the tool 4 will tend to push the instrument toward the bottom of the head 3, in this way avoiding the risk of the instrument escaping from the head 3.

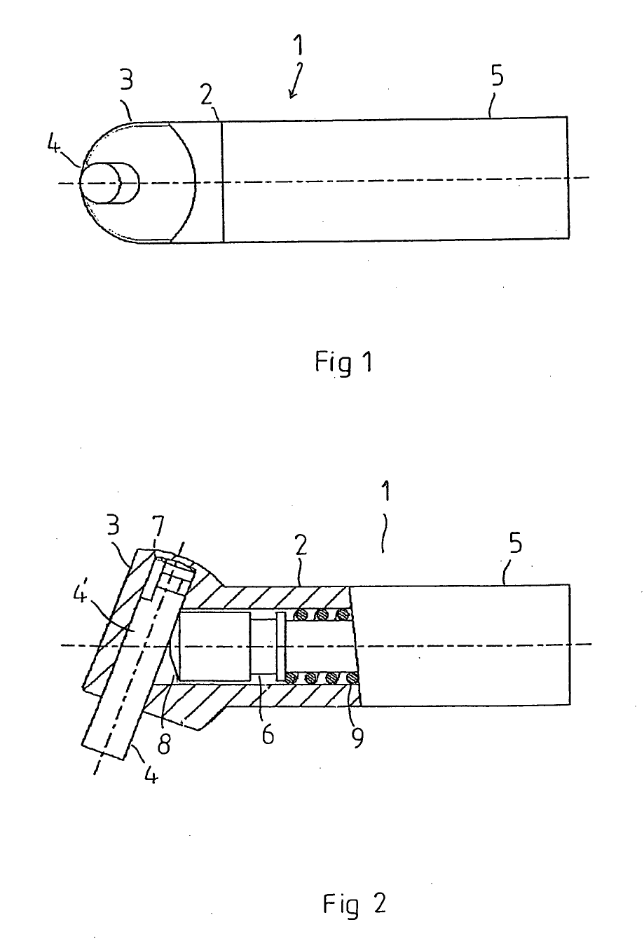

In a first alternative embodiment, which is shown in FIGS. 1 and 2, the drive shaft 6 is provided with a return spring 9 which is housed in the handle 5. The return spring 9 surrounds the outer face of the drive shaft 6, and ensures that the tool 4 can be fitted in place simply by pushing on the drive shaft 6, against the return force of the spring 9. When the tool 4 is introduced into the bore 7 of the head 3 of the handpiece 1, the tool 4 pushes on the drive shaft 6, which draws back against the return force of the spring 9. Similarly, upon disengagement of the tool 4 from the head 3 of the handpiece 1, the drive shaft 6 is pushed toward the front of the head 3 by the return spring 9.

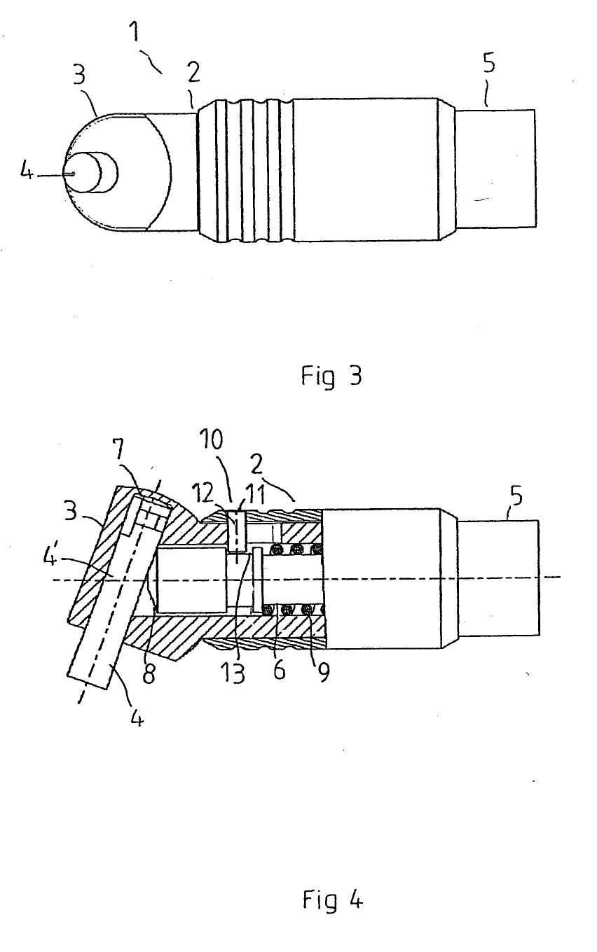

In a second alternative embodiment, which is shown in FIGS. 3 and 4, a release 10 is provided for withdrawing the drive shaft 6 from the head 3 of the handpiece 1, for purposes of controlling engagement and/or disengagement of the tool 4 and the bore 7 of the head 3.

The release 10 is situated on an outer face in the vicinity of the neck 2 of the handpiece 1, and is formed by a ring 11 placed on and over the neck 2 of the handpiece 1. The ring 11 is provided with a stub 12 which engages a groove 13 formed in the drive shaft 6, and which operates to retract the drive shaft 6 from within the head 3, for disengagement of the tool 4, responsive to engagement between the stub 12 and the groove 13 provided in the drive shaft 6. The drive shaft 6 is urged into the head, for engaging a tool 4 located within the bore 7, by the return spring 9 previously described in connection with the first alternative embodiment apparatus of FIGS. 1 and 2.

The drive shaft 6 is situated on a longitudinal axis extending through the handpiece 1, in contrast to the transverse axis of the bore 7 for receiving the tool 4. These differences in plane allow the tool 4 to fit securely at the bottom of the bore 7 responsive to the forces created by the drive shaft 6 during its rotation. This effect is accentuated by the friction drive 8 situated at the end of the drive shaft 6, which is then in contact with the tool 4.

Moreover, such differences in plane allow the drive shaft 6 to be fitted with a slight amount of play. During its rotation, the drive shaft 6 is caused to be situated in an offset position relative to the tool 4, which tends to push the tool 4 to the bottom of the bore 7, in this way preventing the tool 4 from escaping from the bore 7 of the head 3. In addition, and in order to ensure that the apparatus functions correctly both for rightward rotations and for leftward rotations, it suffices to provide the axis of the drive shaft 6 with some play in its seat, in such a way that the drive shaft 6 independently takes up an offset position during such rotations.

It will be understood that while the present invention has been described based on specific embodiments incorporating specified parts, the present invention further encompasses all technical equivalents of the parts described, and that various changes in the details, materials and arrangement of parts which have been herein described and illustrated in order to explain the nature of the present invention may be made by those skilled in the art within the principle and scope of the invention as expressed in the following claims.

What is claimed is:

1. An apparatus for removably fixing a tool to a head of a handpiece, wherein the handpiece includes a neck having the head at one end of the neck and a handle at an opposing end of the neck, wherein interior portions of the neck, the handle and the head each receive a drive shaft for rotating the tool, and wherein the apparatus comprises:
a bore formed in the head of the handpiece, for receiving the tool in the bore of the head; and
a toothless friction drive coupled with an end of the drive shaft adjacent to the bore of the head, for engaging shank portions of the tool while received in the bore of the head, and for retaining the tool in the bore by frictional contact between the shank of the tool and the friction drive coupled with the drive shaft.

2. The apparatus of claim 1 wherein the friction drive is a rubber shroud surrounding the end of the drive shaft.

3. The apparatus of claim 1 wherein the drive shaft further includes a return spring located in the handle of the handpiece, for urging the drive shaft toward the head.

4. The apparatus of claim 3 wherein the handpiece further includes a release coupled with the drive shaft for retracting the drive shaft against spring forces produced by the return spring, and for controlling separation of the drive shaft from the shank of the tool to allow the tool to be withdrawn from or engaged in the bore.

5. The apparatus of claim 4 wherein the release includes a ring surrounding the neck of the handpiece, and wherein the ring includes a stub for engaging a groove formed in the drive shaft.

6. The apparatus of claim 1 wherein the end of the drive shaft adjacent to the bore of the head is provided with an inclined surface for matching the shape of the tool.

7. The apparatus of claim 6 wherein the drive shaft is provided with a frusto-conical surface at the end of the drive shaft adjacent to the bore of the head which is in contact with the shank of the tool.

8. The apparatus of claim 7 wherein the frusto-conical surface is constituted by a plurality of smooth surfaces.

9. The apparatus of claim 1 wherein the bore is formed along a bore axis, wherein the drive shaft is received on a longitudinal axis, and wherein the bore axis and the longitudinal axis of the drive shaft define different axes.

10. The apparatus of claim 9 wherein the drive shaft is mounted in a seat having play, for causing the drive shaft to be offset relative to the tool during rotation.

11. The apparatus of claim 1 wherein the shank of the tool and the drive shaft meet at a defined point of contact, and wherein the shank of the tool and the drive shaft are offset relative to the defined point of contact.
